(19) United States
(12) Patent Application Publication
(10) Pub. No.: US 2015/0002853 A1
(43) Pub. Date: Jan. 1, 2015

(54) MINIATURE SCAN-FREE OPTICAL TOMOGRAPHY SYSTEM

(71) Applicant: Chung Yuan Christian University, Chung Li (TW)

(72) Inventor: I-JEN HSU, Jhongli City (TW)

(21) Appl. No.: 14/488,925

(22) Filed: Sep. 17, 2014

Related U.S. Application Data
(63) Continuation of application No. 13/238,868, filed on Sep. 21, 2011.

(30) Foreign Application Priority Data
Jul. 8, 2011 (TW) 100124181

(51) Int. Cl. G01B 9/02

(52) U.S. Cl. CPC G01B 9/02091; G01B 9/02043
USPC 356/497

(57) ABSTRACT

A miniature scan-free optical tomography system is provided. The system includes a broadband light source. A detection device is composed without a grating in front of it. A beamsplitter splits a light beam emitted from the broadband light source into a first reference light beam and a first sample light beam. An optical delay device including a fixed single curved reflecting surface reflects the first reference light beam into a second reference light beam having different optical path lengths only along a first dimension. The second reference light beam is incident through the beamsplitter to the detection device. A focusing device focuses the first sample light beam only along a third dimension. A second sample light beam reflected from the sample is incident to the detection device. Different portions of the second reference light beam along the first dimension have different optical path lengths.

### CROSS REFERENCE TO RELATED APPLICATIONS

This Application is a Continuation of pending U.S. patent application Ser. No. 13/238,868, filed Sep. 21, 2011 and entitled “SCAN-FREE OPTICAL TOMOGRAPHY SYSTEM”, which claims priority of Taiwan Patent Application No. 100124181, filed on Jul. 8, 2011, the entirety of which is incorporated by reference herein.

### BACKGROUND OF THE INVENTION

1. Field of the Invention

The present invention relates to an optical tomography system, and in particular, to a miniature scan-free optical coherence tomography system.

2. Description of the Related Art

Optical coherence tomography (OCT) was disclosed by J. G. Fujimoto et al. and was published in Science in 1991. Because of its ability for non-destructive two-dimensional or three-dimensional high-resolution tomography of subsurface structure of a material, related technologies and applications were developed rapidly and were paid widespread attention in the past two decades. Especially, OCT has become an important research and diagnostic tool in the field of biomedicine.

OCT is based on the principle of interferometry. It utilizes the interference signals between lights from sample arm and reference arm as the basis for imaging the structure of the sample. In the early development of OCT, time-domain techniques were mainly developed where the longitudinal (axial) scanning of an optical delay line in the reference arm was used to produce optical delay to cause a variation of optical path length in the reference arm with time. The structural information at different depths within the sample can then be obtained. The disadvantage of this technique is the needs of longitudinal (axial) scanning in the reference arm making it difficult to improve the imaging speed.

The subsequently developed Fourier- or frequency-domain OCT replaces the photodetector with spectrometer in the system. The structural information at different depths within the sample can be obtained from Fourier transform of the interference signal. The advantage of this technique is that it can greatly improve the imaging speed without the longitudinal (axial) scanning in the reference arm. However, there are still limitations in this technique such as that the imaging range is limited by the wavelength resolution of the spectrometer, mirror images and auto-correlation signals during Fourier transform. In order to resolve the problem of mirror images and auto-correlation signals, phase shifts in the reference arm are needed. Furthermore, the acquisition of structural information within the sample requires the use of computer program for Fourier transform of the interference signals.

Recently, due to the development of swept laser, the swept-source OCT with the use of swept source to replace the traditional broadband light source and the use of high-speed photodetector to replace spectrometer makes this technology for further improvement. This new technique greatly improves the imaging speed and the wavelength resolution of spectrum. However, the light sources used in this technique are usually high cost. Furthermore, because it is still based on the concept of Fourier- or frequency-domain OCT, a computer program for Fourier transform in order to obtain the structural information within the sample is needed. The problems of mirror images and auto-correlation signals during Fourier transform can neither be avoided.

Thus, a novel optical tomography system is desired to meet the needs mentioned and to overcome the shortcomings of known techniques.

### BRIEF SUMMARY OF INVENTION

A miniature scan-free optical tomography system is provided. An exemplary embodiment of a miniature scan-free optical tomography system comprises a light source emitting a light beam. A detection device is composed by a charge-coupled device (CCD) without a grating in front of it. A beamsplitter splits the light beam emitted from the broadband light source into a first reference light beam and a first sample light beam. An optical delay device comprising a fixed single curved reflecting surface reflects the first reference light beam from the beamsplitter into a second reference light beam and causes the second reference light beam to have different optical path lengths along and only along a first dimension. The second reference light beam reflected from the optical delay device is incident through the beamsplitter to the detection device. A focusing device focuses the first sample light beam from the beamsplitter along and only along a third dimension. A second sample light beam reflected from the sample is incident through the beamsplitter to the detection device. Different portions of the second reference light beam along the first dimension have different optical path lengths. The broadband light source, the detection device, the beamsplitter, the optical delay device and the focusing device are integrated and configured to be sealed in a capsule-like compartment without any mechanism for scan or phase shift.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross section view showing one exemplary embodiment of a miniature scan-free optical tomography system of the invention.

FIG. 2 is a schematic diagram showing a light path of a light beam emitted from a light source and light paths of a first reference light beam and a first sample light beam from the light beam split by a beamsplitter.

FIG. 3 is a schematic diagram showing a light path of a second reference light beam reflected from an optical delay device.

FIG. 4 is a schematic diagram showing a light path of a second sample light beam reflected from a sample.

FIG. 5 is a schematic diagram showing a tomographic camera/capsule tomographic endoscope formed of one exemplary embodiment of a miniature scan-free optical tomography system of the invention.

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the invention.

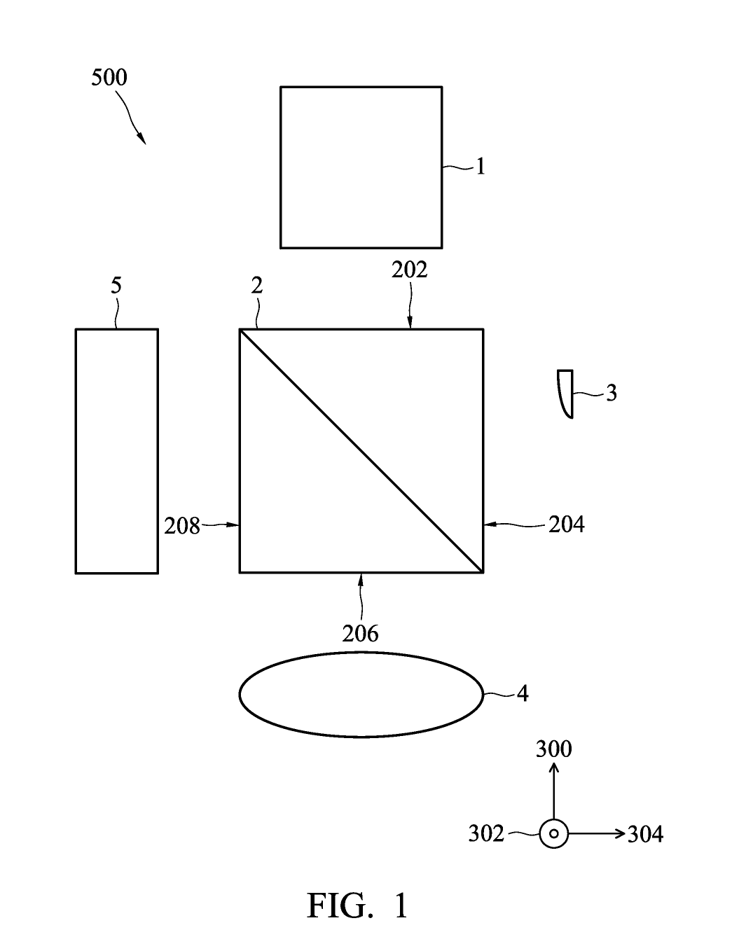

FIG. 1 is a cross section view showing one exemplary embodiment of a miniature scan-free optical tomography system 500 of the invention. One exemplary embodiment of a miniature scan-free optical tomography system 500 is an optical coherence tomography system. The reference arm of an interferometer of the miniature scan-free optical tomography system 500 is not required to scan along a longitudinal (axial) direction. Also, interference signals received in the interferometer are not required to be Fourier transformed using the computer program. Please refer to FIG. 1: one exemplary embodiment of a miniature scan-free optical tomography system 500 comprises a light source 1, a beamsplitter 2, an optical delay device 3, a focusing device 4 and a detection device 5. The beamsplitter 2, the optical delay device 3, the focusing device 4 and the detection device 5 collectively construct an interferometer of the miniature scan-free optical tomography system 500. When a light emitted from the light source 1 is respectively incident on a sample and the optical delay device 3, two reflected light beams are formed. The two reflected light beams generate an interference signal detected by the detection device 5. As shown in FIG. 1, the light source 1, the optical delay device 3, the focusing device 4 and the detection device 5 are respectively disposed on a first side 202, a second side 204, a third side 206 and a fourth side 208 of the beamsplitter 2. Meanwhile, positions for disposing the light source 1, the optical delay device 3, the focusing device 4 and the detection device 5 described herein are exemplary only and are not limiting. It is noted that, a distance between the optical delay device 3 and the beamsplitter 2 is held at a fixed value.

In one embodiment, the light source 1 may be a broadband light source having a continuous wavelength (or frequency) distribution. In one embodiment, the beamsplitter 2 may be a beam splitting mirror. In one embodiment, the optical delay device 3 is a fixed single curved reflecting surface which causes an optical path length distribution or an optical delay distribution for different portions of a reflected beam along a first dimension (a first dimension 300 parallel to a surface of the figure in FIG. 1) passing therethrough, and causes the same optical path length for different portions of a reflected beam along a second dimension (a second dimension 302 perpendicular to the surface of the figure in FIG. 1) passing therethrough. For example, the optical delay device 3 may comprise a cylindrical mirror. The cylindrical mirror may extend along the second dimension (the second dimension 302 perpendicular to the surface of the figure in FIG. 1). The first dimension 300 and the second dimension 302 are defined as dimensions perpendicular to the light axis (the direction of propagation of the light beam). Also, the first dimension 300 and the second dimension 302 are perpendicular to each other. One exemplary embodiment of the focusing device 4 may be able to focus the first sample light beam only along a third dimension 304, but not along the second dimension 302. The third dimension 304 is parallel to the surface of the figure in FIG. 1, and the third dimension 304 is perpendicular to both of the first dimension and the second dimension. In this embodiment, the focusing device 4 may be a convex cylindrical lens extending along the second dimension 302. In one embodiment, the detection device is a two-dimensional (2D) charge-coupled device (CCD), for example, a digital camera, to detect a two-dimensional light.

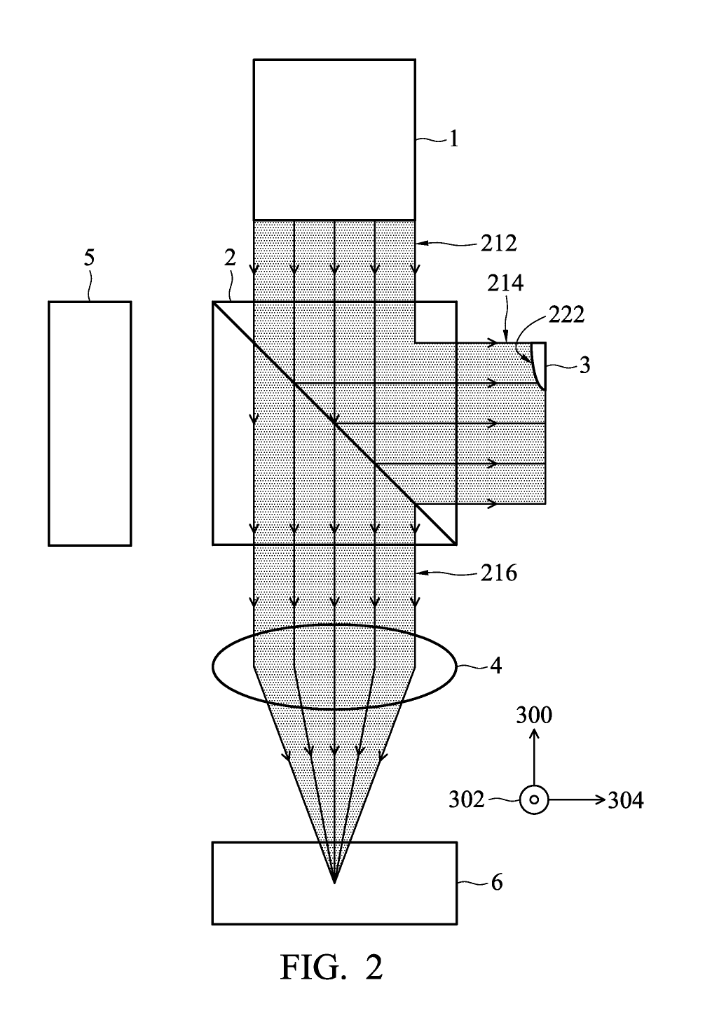

Next, FIGS. 2 to 4 describe an optical coherence tomography using one exemplary embodiment of a miniature scan-free optical tomography system 500 of the invention. FIG. 2 is a schematic diagram showing a light path of a light beam 212 emitted from a light source 1 and light paths of a first reference light beam 214 and a first sample light beam 216 from the light beam 212 split by a beamsplitter 2. Different line segments of the first reference light beam 214 and the first sample light beam 216 serve as light paths, and directions indicated by arrows of the line segments illustrate directions of propagation of light. As shown in FIG. 2, a light beam 212 is emitted from a light source 1. In this embodiment, the light source 1 is a broadband light source. Therefore, the light beam 212 may serve as a broadband light beam 212. The light beam 212 may be split into two light beams, which are a first reference light beam 214 and a first sample light beam 216, by the beamsplitter 2. A portion of the first reference light beam 214 may be incident on the optical delay device 3 such as a cylindrical mirror. Additionally, the first sample light beam 216 may be incident into the focusing device 4, thereby being focused on a sample 6 by the focusing device 4. In this embodiment, because the focusing device 4 is able to focus the first sample light beam 216 only along the third dimension 304 but not along the second dimension 302, the first sample light beam 216 focused on the sample 6 has a strip shape along the second dimension 302.

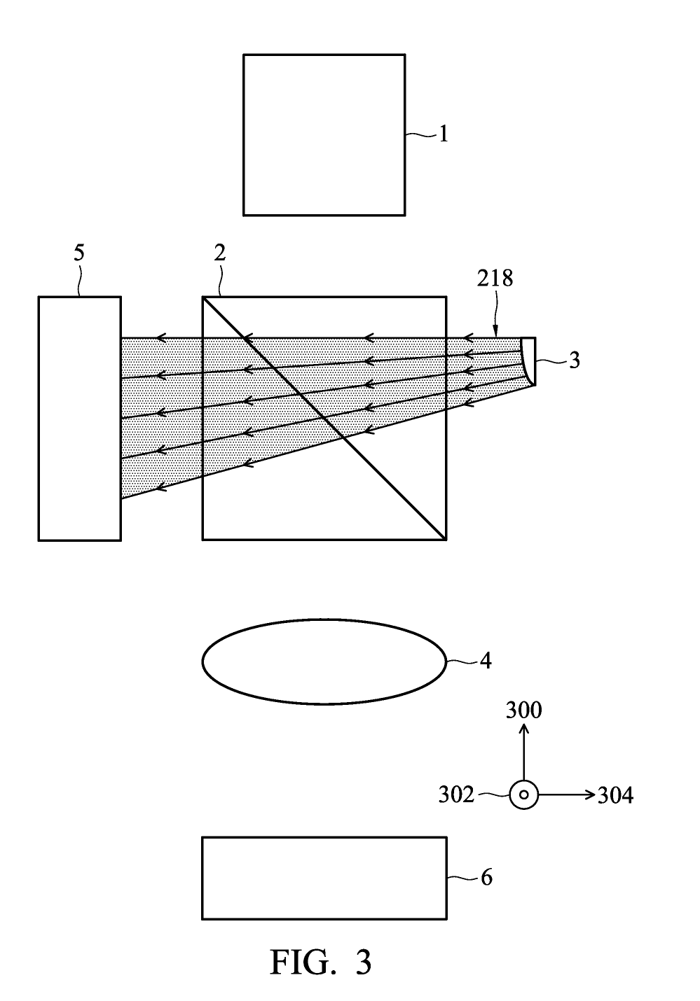

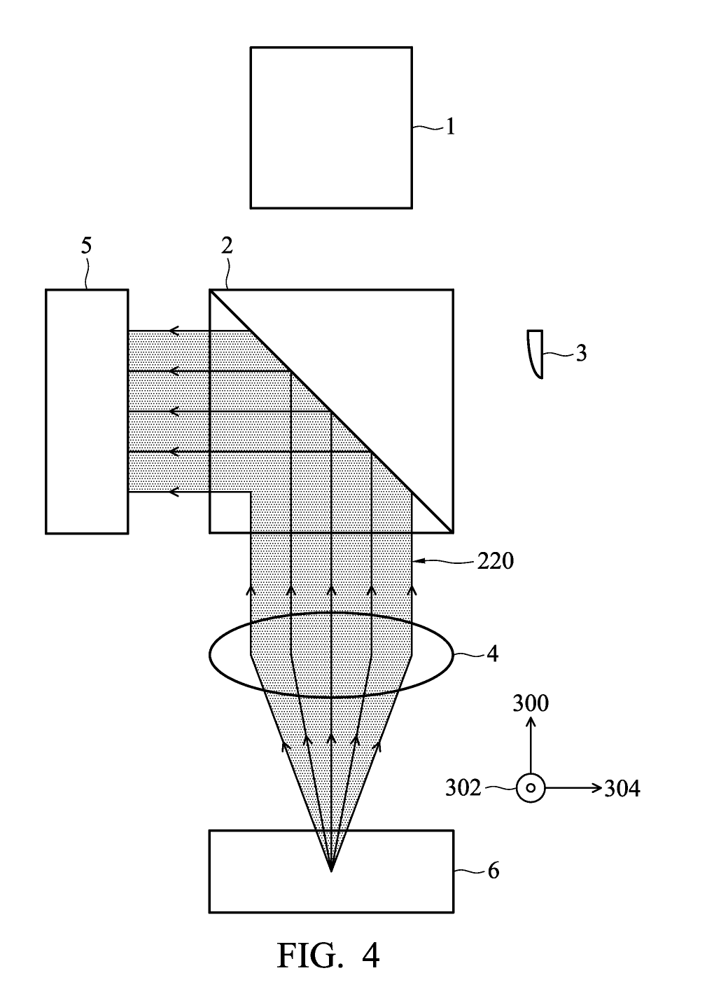

As shown in FIGS. 3 and 4, the optical delay device 3 and the sample 6 may respectively reflect the first reference light beam 214 and the first sample light beam 216 and form a second reference light beam 218 and a second sample light beam 220. FIG. 3 is a schematic diagram showing a light path of a second reference light beam 218 reflected from an optical delay device 3. Different line segments of the second reference light beam 218 serve as different light paths of the second reference light beam 218, and directions indicated by arrows of the line segments illustrate directions of propagation of light of the second reference light beam 218. As shown in FIG. 3, the second reference light beam 218 reflected from an optical delay device 3 may transmit through the beamsplitter 2 and incident on the detection device 5. The second reference light beam 218 has the optical path length distribution (optical delay distribution) along the first dimension 300 (parallel to the surface of the figure). That is to say, different portions of the second reference light beam 218 along the first dimension 300 have different optical path lengths, but the second reference light beam 218 along the second dimension 302 has the same optical path length. In other words, for the light beam split by the beamsplitter 2, reflected by the optical delay device 3 and then transmitted to the detection device 5, different portions of the light beam (different line segments of the second reference light beam 218) along the first dimension 300 have different optical path lengths.

FIG. 4 is a schematic diagram showing a light path of a second sample light beam 220 reflected from a sample 6. Different line segments of the second sample light beam 220 serve as light paths of the second sample light beam 220, and directions indicated by arrows of the line segments illustrate directions of propagation light of the second sample light beam 220. As shown in FIG. 4, the second sample light beam 220 reflected or back scattered by the sample 6 may transmit the focusing device 4, and then be reflected by the beamsplitter 2, and then incident on the detection device 5. In this embodiment, because the focusing device 4 focuses the first sample light beam 216 only along the third dimension 304 but not along the second dimension 302, the first sample light beam 216 focused on the sample 6 has a strip shape along the second dimension 302 as shown in FIG. 2. In the FIG. 4, different portions of the second sample light beam 220 incident to the detection device 5 along the first dimension 300 (parallel to the surface of the figure) illustrate reflected light at the same longitudinal axis (along the direction of propagation of the light) of the sample 6. Different portions of the second sample light beam 220 incident to the detection device 5 along the second dimension 302 (perpendicular to the surface of the figure) illustrate reflected light portions from different positions of the sample 6 along the second dimension 302.

As shown in FIGS. 3 and 4, the second reference light beam 218 reflected from the optical delay device 3 and the second sample light beam 220 reflected from the sample 6 may be both incident to the detection device 5 through the beamsplitter 2. It is noted that the light beam distributed along the first dimension 300 on the optical delay device 3 and, and the light beam distributed along the third dimension 304 on the focusing device 4 coincide along the first dimension 300 at the detection device 5 after respective reflection and transmission through the beamsplitter 2. Therefore, the detection device 5 may receive interference image of the second reference light beam 218 and the second sample light beam 220. Because different portions of the second reference light beam 218 have different optical path lengths along the first dimension 300 and have the same optical path length along the second dimension 302, an optical path length variation at a reference arm can be generated without moving (scanning) the optical delay device 3. Additionally, the different portions of the second sample light beam 220 incident to the detection device 5 along the first dimension 300 (parallel to the surface of the figure) illustrate reflected light at the same longitudinal axis (along the direction of propagation of the light) of the sample, and the different portions of the second sample light beam 220 incident to the detection device 5 along the second dimension 302 (perpendicular to the surface of the figure) illustrate reflected light portions from different positions of the sample 6 along the second dimension 302. Therefore, a component of the interference image along the first dimension 300 may correspond to structural information of the sample 6 in the longitudinal direction (the direction of propagation of the light beam in the sample 6), which shows a structural information at different depths in the sample 6. Also, a component of the interference image along the second dimension 302 may correspond to structural information of the sample 6 along the second dimension 302, which shows structural information at different positions of the sample 6 along the second dimension 302. Therefore, the interference image received by the detection device 5 may correspond to a two-dimensional (2D) tomographic image of the sample 6.

One exemplary embodiment of a miniature scan-free optical tomography system of the invention is provided. The miniature scan-free optical tomography system uses an optical delay device 3 which can spatially expand the light beam to replace the longitudinal scanning component of the time-domain optical coherence tomography system for an optical path length variation of the reference light beam. Therefore, image information equivalent to that of the conventional time-domain optical coherence tomography can be obtained by a fixed optical delay device 3 in the reference arm without scanning. The imaging speed can be improved. Also, the miniature scan-free optical tomography system can avoid the requirement of Fourier transform and the problems of mirror image and auto-correlation signals in the conventional Fourier-domain (frequency-domain) optical coherence tomography system. Therefore, one exemplary embodiment of a miniature scan-free optical tomography system of the invention is also referred to as a “transform-free single-shot optical coherence tomography system”.

Additionally, because the focusing light beam (the first sample light beam) has a strip shape along the second dimension but not a single spot on the surface of the sample, and the miniature scan-free optical tomography system uses a two-dimensional light detection device for acquisition of the signal, the two-dimensional tomographic image of the sample is obtained without scanning and Fourier transform in real time. A three-dimensional (3D) tomographic image of the sample can be obtained by scanning the sample along another dimension different to the first and second dimensions.

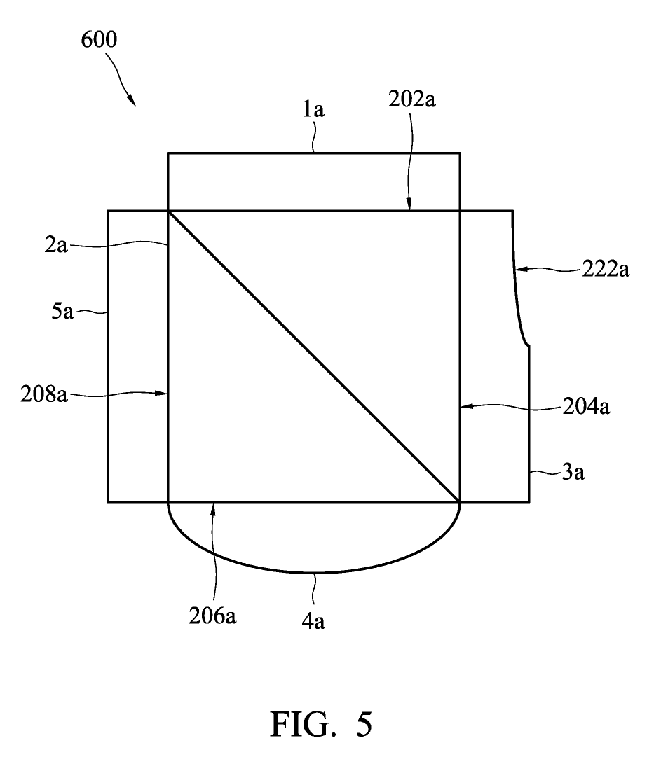

Applications of one exemplary embodiment of a miniature scan-free optical tomography system of the invention may comprise an optical coherence tomography system, miniaturized optical coherence tomography system, portable optical coherence tomography system and etc. Specially, a position of the optical delay device in the reference arm of the miniature scan-free optical tomography system can be fixed without any mechanism for scan or phase shift. Therefore, one exemplary embodiment of a miniature scan-free optical tomography system can be used as a tomographic camera, tomographic video camera or a capsule tomographic endoscope, which has a size smaller than the human gastrointestinal tract. Two-dimensional (2D) or three-dimensional (3D) tomographic images of the human gastrointestinal tract can be obtained without injecting a contrast agent or radiopharmaceutical. FIG. 5 is a schematic diagram showing a tomographic camera/capsule tomographic endoscope 600 formed of one exemplary embodiment of a miniature scan-free optical tomography system of the invention. As shown in FIG. 5, one exemplary embodiment of a tomographic camera/capsule tomographic endoscope 600 comprises elements of a light source 1a, a beamsplitter 2a, an optical delay device 3a, a focusing device 4a and a detection device 5a. The elements may be encapsulated into an integrated body, for example, a capsule-like compartment. The light source 1a, the optical delay device 3a, the focusing device 4a and the detection device 5a of the tomographic camera/capsule tomographic endoscopy 600 may be close or adjacent to four sides 202a, 204a, 206a and 208a of the beamsplitter 2a to decrease the total volume. Also, a device of curved reflective surface 222a may be used as the optical delay device 3a.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A miniature scan-free optical tomography system, comprising:
a broadband light source emitting a light beam;
a detection device without a grating in front of it;
a beamsplitter splitting the light beam emitted from the broadband light source into a first reference light beam and a first sample light beam;
an optical delay device comprising a fixed single curved reflecting surface reflecting the first reference light beam from the beamsplitter into a second reference light beam and causing the second reference light beam to have different optical path lengths along and only along a first dimension, wherein the second reference light beam reflected from the optical delay device is incident through the beamsplitter to the detection device; and
a focusing device focusing the first sample light beam from the beamsplitter along and only along a third dimension, wherein a second sample light beam reflected from the sample is incident through the beamsplitter to the detection device,
wherein different portions of the second reference light beam along the first dimension have different optical path lengths,
wherein the broadband light source, the detection device, the beamsplitter, the optical delay device and the focusing device are integrated and configured to be sealed in a capsule-like compartment without any mechanism for scan or phase shift.

2. The miniature scan-free optical tomography system as claimed in claim 1, wherein different portions of the second reference light beam along a second dimension have the same optical path length, and the first dimension and the second dimension are perpendicular to each other.

3. The miniature scan-free optical tomography system as claimed in claim 2, wherein the first dimension and the second dimension are both perpendicular to the incident direction of the first reference light beam.

4. The miniature scan-free optical tomography system as claimed in claim 1, wherein the focusing device is a convex cylindrical lens.

5. The miniature scan-free optical tomography system as claimed in claim 3, wherein the focusing device is able to focus the first sample light beam along a third dimension but not along the second dimension, and the third dimension is perpendicular to the first dimension and the second dimension.

6. The miniature scan-free optical tomography system as claimed in claim 3, wherein the first sample light beam focused to the sample by the focusing device has a strip shape along the second dimension.

7. The miniature scan-free optical tomography system as claimed in claim 1, wherein the detection device is a two-dimensional light detection device.
